(19) United States
(12) Patent Application Publication
(10) Pub. No.: US 2002/0029339 A1
(43) Pub. Date: Mar. 7, 2002

(54) Method and apparatus for facilitating monetary and commercial transactions and for securely storing data

(76) Inventor: Rick Rowe, Reno, NV (US)

Correspondence Address: R. Scott Weide, Weide & Associates, Ltd., 11th Floor, Suite 1130, 330 S. 3rd Street, Las Vegas, NV, 89101, US

(21) Appl. No.: 09/794,486

(22) Filed: Feb. 26, 2001

Related U.S. Application Data
(60) Provisional application No. 60/185,568, filed on Feb. 28, 2000.

(51) Int. Cl. H04L 9/32; G06F 17/60

(52) U.S. Cl. 713/182; 705/77

(57) ABSTRACT

One or more methods and apparatus for facilitating monetary and commercial transactions is disclosed. One or more embodiments of the invention comprise a method of a customer establishing a financial account with an account provider, the account having features particularly useful in facilitating monetary and commercial transactions. This method comprises the steps of providing customer data to the account provider, establishing an account type, assigning a value limit for the account, depositing funds in the financial account in an amount not exceeding the value limit, assigning the financial account an expiration date after which access to the financial account is generally prohibited by a user, and generating an account signature for use in establishing later entitlement to access the financial account. One or more embodiments of the invention comprise an account which is particularly useful in facilitating monetary and commercial transactions. The financial account has monetary funds associated therewith which may be debited from the account, an expiration date associated therewith after which access to the account is prevented, a maximum funds value comprising the maximum funds which may be associated with the account, and account data for use in establishing entitlement to access the account. One or more other embodiments of the invention comprise methods and apparatus for securely storing data.

### FIELD OF THE INVENTION

The present invention relates to methods and devices for permitting monetary transactions, such as the transfer of funds and the payment of monies, for facilitating commercial transactions, such as the purchase of goods, and for securely storing data.

### BACKGROUND OF THE INVENTION

A variety of methods and devices are currently available for facilitating the purchase of goods or services and the transfer of money. Some of the devices include cash, checks and credit cards. Some of the methods include by mail or in-person payments and wire transfers. These current methods and devices have numerous limitations, some of which are evident when considering a variety of situations.

One limitation relates to the ability of minors to make purchases. In the past, minors have generally made purchases in cash or check either tendered directly to the vendor at the vendor's location or mailed to the vendor. With the advent of the Internet and telephonic phone orders, consumers are now offered the ability to purchase goods on-line or over the phone, remote from the vendor offering the goods or services. A primary advantage or purchasing goods in these manners is that the time delay associated with mailing an order to the vendor is eliminated. In either case, however, to realize these speed advantages, the customer must tender payment to the remote vendor at the time the order is placed instead of mailing payment to the vendor. As such, nearly all on-line and telephonic purchases are facilitated by use of a credit card. A user places an order and provides their credit card information, either directly to a representative of the vendor or via data input on-line. A retailer then uses the card information to receive payment from the authority issuing the credit to the user of the credit card.

Generally, minors do not have access to credit cards. One reason for this is that under the law, minors are not necessarily legally bound to their actions. Thus, a credit issuing authority which issues a card to a 17 year old may find that it can not force the minor to pay any debts incurred by using the card. In addition, parents wishing to teach their children financial responsibility often do not wish to provide cards to their children where they can not monitor and control the expenditures by the child.

ATM or “automated teller machine” cards are available which are linked to a bank account. These cards permit a user to withdraw funds from their account, such as at a cash dispensing machine. Some of these cards may also be accepted by retailers, both on the Internet and at the retailer's location. A significant problem with these cards is that they are linked to the user's primary bank account. If the user's card information is intercepted, such as during an on-line transaction, a thief may be able to completely empty the user's primary banking account of all funds. In addition, a user may not even be aware that their card has been misplaced or lost for a long period of time during which another party may find the card and access their account.

Currently, there is also no convenient means for providing gifts or promotions to consumers which is compatible both with standard retail store and on-line purchasing. For example, a gift giver may travel to a store and purchase a “gift certificate” to the store. The gift certificate comprises a paper check, magnetic striped card or similar item. The recipient of the gift may travel to the store and present the gift certificate to serve as payment for goods. Unfortunately, the recipient of the gift certificate must travel to the store to use it. In many situations, this is undesirable, such as when the gift recipient lives far from the store where it was purchased.

Another problem with gift certificates is that they are limited in their acceptance. Both those who give and receive gift certificates desire the ability to use the gift certificate at a wide variety of locations, permitting the gift recipient maximum latitude in selecting their gift. Gift certificates are sometimes available for use at a number of stores at a particular location. These gift certificates are issued by a central authority, such as a mall at which all of the stores are located. These certificates are not otherwise accepted, however.

Another current problem relates to the storage and access of important data. This data may comprise bank account and other personal data, such as photographs, legal documents, tax and business data, health records and the like. In some instances, the data is printed on a document, and in others, it may be stored in electronically readable form on a computer disk, hard drive or other media. Currently, this data is generally stored at a perceived safe location in one's home, or in a physical lock box, i.e. “safe deposit box,” at a bank or similar secure location.

Of course, storage of important data at one's home is risky. First, the data may be destroyed. For example, a computer hard drive may become corrupt or the data may be deleted inadvertently. The data may also be destroyed by fire or stolen. Storage of the data in a physical safe deposit box has the advantage of being less apt to theft and destruction, but the data is also very inaccessible. A party must drive to the storage location, such as a bank, and present identification and a key to be used with a key of the storage facility in order to gain access to the data. The data may then need to be transported to the person's home or the like for use, and then transported back to the bank for storage again.

It is desirable to provide one or more methods and devices which serve to facilitate monetary and commercial transactions, and for securely storing data in a manner overcoming the above-stated limitations.

### SUMMARY OF THE INVENTION

The present invention comprises one or more methods and apparatus for facilitating financial and commercial transactions, and for securely storing data.

One or more embodiments of the invention comprise a method of a customer establishing a financial account with an account provider, the account having features particularly useful in facilitating monetary and commercial transactions. This method comprises the steps of providing customer data to the account provider, establishing an account type, assigning a value limit for the account, depositing funds in the financial account in an amount not exceeding the value limit, assigning the financial account an expiration date after which access to the financial account is generally prohibited by a user, and generating an account signature for use in establishing later entitlement to access the financial account.

One or more embodiments of the invention comprise an account which is particularly useful in facilitating monetary and commercial transactions. The financial account has monetary funds associated therewith which may be debited from the account, an expiration date associated therewith after which access to the account is prevented, a maximum funds value comprising the maximum funds which may be associated with the account, and account data for use in establishing entitlement to access the account.

One or more embodiments of the invention comprise a method of facilitating a commercial transaction comprising establishing a financial account, the account having a maximum funds limit, funds associated therewith not exceeding the limit, an expiration date after which commercial transactions are prohibited, and account access data, a customer activating the account in order to utilize the account, determining if the customer wishes to utilize the account to facilitate a commercial transaction, determining if access to the account is permitted if it is determined that the customer wishes to utilize the account, and if access is permitted, and debiting funds from the account in order to facilitate the transaction.

One or more embodiments of the invention comprise methods and apparatus for securely storing data. In accordance with one embodiment of a method, a user transmits data from a first location, such as the user's computer, to a second, remote location, such as a remote server. Identifying information is associated with the transmitted data. This information may include information identifying the user and the date/time the data was received. The data is then encrypted and stored at the remote location.

One or more embodiments of the invention comprise a method of accessing securely stored data and manipulating the data, such as by deleting it.

Further objects, features, and advantages of the present invention over the prior art will become apparent from the detailed description of the drawings which follows, when considered with the attached figures.

### DESCRIPTION OF THE DRAWINGS

FIG. 1 is a flow diagram illustrating a method in accordance with the present invention;

FIG. 1(a) is a flow diagram illustrating in detail a method comprising a step of establishing an account in accordance with the method illustrated in FIG. 1;

FIG. 1(b) is a flow diagram illustrating in detail a method comprising a step of activating an account in accordance with the method illustrated in FIG. 1;

FIG. 1(c) is a flow diagram illustrating in detail a method comprising a step of determining if access to an account is permitted in accordance with the method illustrated in FIG. 1;

FIG. 1(d) illustrates various flow diagrams of methods comprising a variety of methods of utilizing an accordance in accordance with the method illustrated in FIG. 1;

FIG. 2(a) is a flow diagram illustrating a method of storing a file securely in accordance with the present invention;

FIG. 2(b) is a flow diagram illustrating a method of accessing a secure file stored in accordance with the method illustrated in FIG. 2(a); and

FIG. 2(c) is a flow diagram illustrating a method of deleting a file stored in accordance with the method illustrated in FIG. 2(a).

### DETAILED DESCRIPTION OF THE INVENTION

The invention comprises one or more methods and apparatus for facilitating monetary and commercial transactions, and one more methods and apparatus for securely storing data. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention

In general, one aspect of the invention comprises one or more methods and apparatus for facilitating transactions, such as monetary funds transfers and purchases, and especially those occurring at least partially electronically. The invention also comprises methods and apparatus for facilitating commercial transactions, such as the purchase of goods and services.

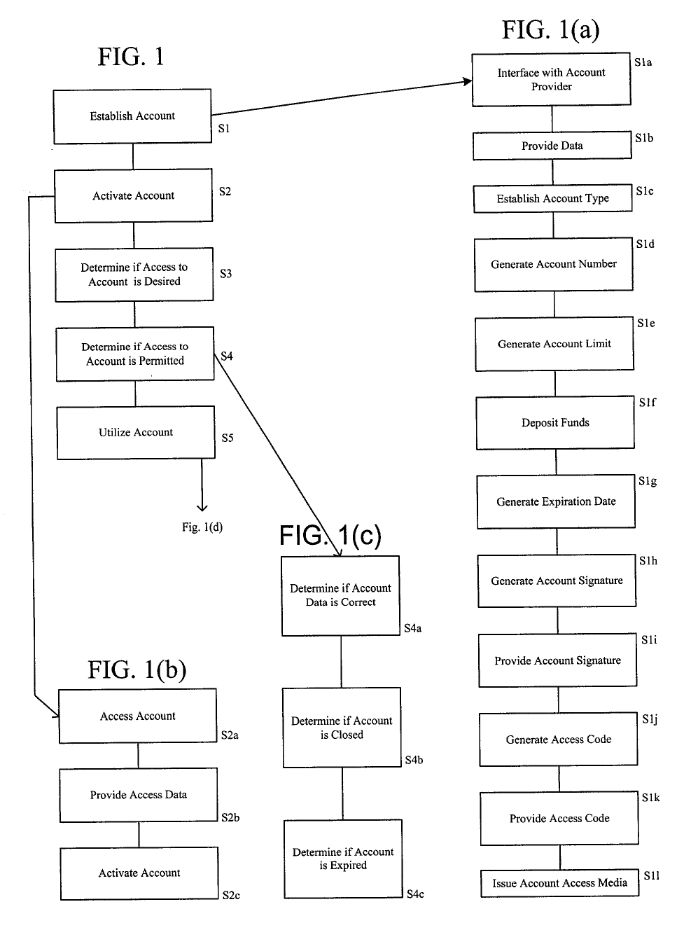

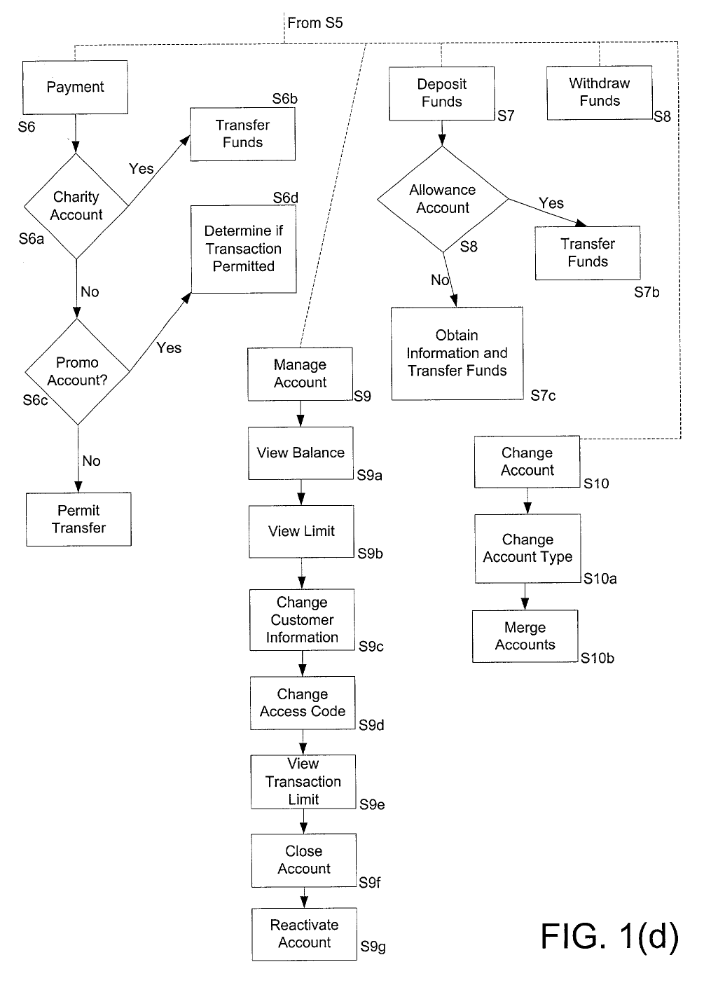

Referring to FIG. 1, one or more embodiments of a method of the invention will be described. First, in a step S1, an account is established. The account may be established by a party for use by themselves or for use by others. As used herein, the person who establishes the account is generally referred to as a customer, regardless of whether that person is establishing the account for themselves or another party or user.

The account is established by an account provider. The account provider may be a retailer, bank or other entity. As provided below, regardless of whether the account is referred to as a financial, bank, debit, monetary or other named account, the account has certain characteristics that define it.

Referring to FIG. 1(a) there will be described one or more methods for establishing an account. In a first step S1a, a customer interfaces with an account provider. This step may comprise the customer accessing a website belonging to the account provider, calling an account provider customer representative, or accessing one or more other means now known or later developed by which the customer may provide information to the account provider.

In a step S1b, the customer provides data to the account provider. This data is used to set up the account. The particular data which is required may vary by provider. In one or more embodiments, the data may include the customer's name and/or the name(s) of the parties which are to be permitted to access the account, address, telephone number, social security number, birth date, mother's maiden name and/or other information. In the event the customer is a business, the information may comprise the business name, address, telephone number, taxpayer identification number and/or similar information.

The particular manner by which this information is transmitted to the account provider may depend upon the interface the customer is using. For example, the data may be input into a graphical user interface associated with the account provider's website and then sent to the account provider's computer, such as over the Internet. The data may be provided orally over the phone by the customer to the account provider.

In a step S1c, an account type is established. In one or more embodiments, the account type may comprise one or more of the following: customer debit, charity debit, promotional, or allowance account.

A customer debit account is preferably of the type where funds belonging to the customer are assigned or credited to the account, and payments, transfers and the like are associated with debits of these funds from the customer's account. This is opposite to a credit type account where those funds which are debited belong to the account provider or other creditor with the requirement that the customer repay the account provider with their funds at a date after a particular transaction. In general, the customer debit account permits a customer to make and pay for purchases, obtain funds (such as currency), and transfer funds into and out of the account.

A charity debit account is preferably of the type where the customer may only transfer funds from the account to an authorized charity or similar entity, with no other debits permitted (except return of the funds to the customer or transfer of funds to another account belonging to another account at the specific instruction of the customer). Generally, the customer will provide the account provider specific information about the charity to which funds are to be transferred. The customer may arrange the account such that funds are debited and transferred to the charity at one or more predetermined times and for one or more predetermined amounts.

A promotional account is preferably of the type where the customer is a promoter arranging an account for use by one or more other parties. For example, the promoter may be a store owner and the parties who may use the account may comprise customers or potential customers of the store. The promotional account is arranged so that the parties or users may access the account in accordance with the terms of a promotion offered by the promoter. A promoter may establish an account having funds permitting a number of parties to pay for a certain dollar amount of goods purchased at their store via the promotional account. For example, a promoter may establish a promotion for a number of parties, such as 1000 existing customers, whereby $10 of each purchase from the promoter over $20 is payed for by the promoter. The $10 payment may be debited from the promotional account at the time each party makes a qualifying purchase to credit the parties' payment of the goods or services.

An allowance account is preferably of the type where funds are arranged to be periodically transferred into the account. Such an account may be extremely useful to parents having children. In accordance with this account arrangement, funds are periodically transferred into the account for subsequent use. The funds may be transferred from another established account, or an account or other source not associated with the account provider. For example, parents may establish a customer account from which finds are periodically transferred, such as every two weeks, into an allowance account which is accessible by one or more of their children. These children may access the allowance account to pay for books and the like. In this manner, the parents may control (and as described below, track) the spending of their children or other parties which have access to the account.

Those of skill in the art will appreciate that the particular type(s) of accounts and their various features or characteristics may be different than those provided above. For example, an account may have one or more features associated with more than one of the account types provided above.

In a step S1d, the account provider generates an account number and associates the account number with the account. The account number may be used by the account provider and customer to identify the account.

In a step S1e, the account provider assigns the account with a maximum funds value or value limit. In general, this value may be selected by the customer. Most often, the maximum value will comprise the amount of an initial deposit into the account by the customer. In one or more embodiments, the account provider may only offer accounts having pre-set limits, such as $50, $100, $250 or $500.

In a step S1f funds are deposited into the account. Preferably, the maximum amount of funds which may be deposited into the account does not exceed the finds maximum value associated with the account.

In one or more embodiments, the customer provides data which permits the account provider to obtain funds electronically. In one or more embodiments, this comprises providing the account provider with a routing number for a checking or savings account at a bank, account and access information for an ATM card linked to an account, or a credit card. In one or more embodiments, a customer may be permitted to deposit funds by mail or similar non or partially non-electronic manner.

In a step S1g, the established account is assigned an expiration date. In one or more embodiments of the invention, this step comprises associating date data with the account. The expiration date may be generated in a wide variety of manners. The expiration date may comprise a date which is determined by adding a fixed period of time to the date on which the account is established or, as described below, the date on which the account is activated. As described below, the account is arranged such that when the actual date reaches the expiration date, the account can not be accessed except by the account provider.

In a step S1h, an account signature is generated and associated with the account. The signature comprises a unique code or other element for establishing entitlement to access the account. In one or more embodiments, the account provider generates the code based on one or more elements of data associated with the account, such as customer provided data, the initial funds deposit amount, the account number, the account expiration date and/or one or more other elements. In one or more embodiments, the account signature is generated from, or includes, an access code or personal identification number (PIN) data assigned to or selected by the customer as described below. In one or more embodiments, the data used to generate the signature may be input into an encryptor to generate an output which comprises the account signature. The account signature may be generated randomly as well. Preferably, whatever means is used to generate the signature, each signature is unique for a particular account.

In a step S1i, the account signature is provided to the customer. In one or more embodiments, the account signature is mailed to the customer, told over the phone by a customer representative of the account provider to the customer, or is transmitted electronically to the customer. As described below, in the event the customer is provided with an account access media, then the account signature may be provided on the account media. The account signature may be printed on, embossed in, or encoded on the account media or an element associated therewith.

In a step S1j, an account access code is generated and associated with the account. In one or more embodiments, the account provider generates the access code. In other embodiments, the customer generates the code and provides it to the account provider. The access code may comprise a personal identification number or “PIN” comprising one or more letters and/or numbers.

In a step S1k, the access code is provided to the customer. In the case where the customer selects the access code, this step is completed at the same time as step S1h. When the account provider generates the code, the code may be mailed, electronically transmitted or spoken to the customer.

In a step S1l, in one or more embodiments, the customer is provided with an account access. media. The access media may comprise a card, check, ticket, chip or a wide variety of other items. In one or more embodiments, the account signature is associated with the access media. When the access media comprises a card, check or the like, the account signature and/or account may be printed or encoded thereon. The account signature may be provided in one or two-dimensional bar code form or be encoded in a magnetic stripe or a chip or other data storage element associated with the media.

The account signature and/or access code may comprise a physical characteristic of the customer. For example, the access code may comprise a fingerprint or the customer's retinal features. In general, the account number, signature and access code are for use in identifying the particular account and ensuring that only those parties with authority to access an account can do so. A variety of other methods and devices may be used for these purposes.

A variety of other steps and may be associated with the establishment of an account for the customer, and the steps described above need not be completed in the order in which they were described.

Referring again to FIG. 1, in a step S2, an account which the customer wishes to access is activated. Normally, this step will be in response to a customer wishing to access a newly established account.

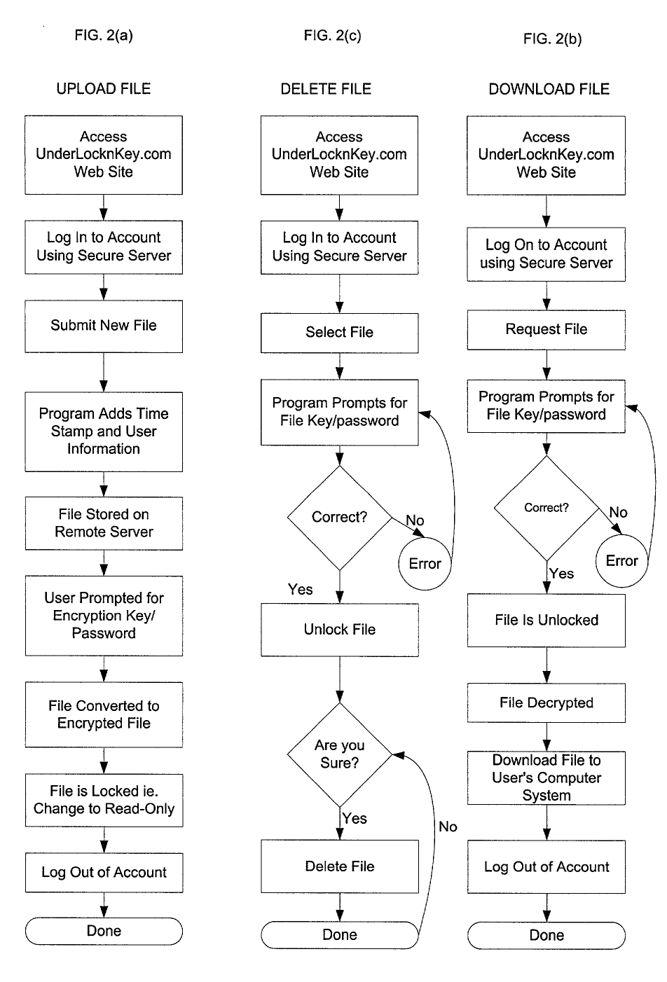

Referring to FIG. 2(a), there is illustrated one embodiment of a method of activating an account in the event the account has not been activated. In a first step S2a, the customer accesses the account. In one or more embodiments, this step comprises a customer contacting the account provider, such as via a website of the account provider or by telephone with a customer service representative.

In a second step S2b, the customer provides their account number, signature and, in one or more embodiments, the access code. This account identification and access data may be provided by a customer telling an account representative the information, typing the information into a data input accepting element of a graphical user interface of a website, or otherwise transmitting such to the account provider. In one embodiment, the account number and signature may be scanned off of an account media provided the customer, such as with a magnetic stripe or bar code reader.

In a step S2c, the account provider activates the account. In one or more embodiments, this step comprises associating data with the account which indicates that the customer and/or other designated and/or appropriate parties may utilize and access the account.

The account activation may be accomplished in a wide variety of other manners. For example, in one embodiment, a customer may activate an account by simply calling a phone number of the account provider or entering the appropriate data into the account provider's website. In this arrangement, it is not necessary for the customer to access the account or provide all of the account information which may be necessary for the customer to use the account.

In one embodiment, an account may be activated for use by a customer at the time it is established. In such an arrangement, any access media associated therewith may be separately activated. For example, the account may be activated when established, allowing a customer to make deposits, funds transfers or the like through an account provider representative or website. However, the customer may not be permitted to utilize an account media (such as for purchases or cash withdraws) until the customer activates the account as to the media. The customer may activate an access card by calling a representative of the account provider after the card is received or other means.

Referring again to FIG. 1, in a step S3 it is determined if a customer wishes to access an account, as by a customer's attempted use of the account. This step may be remote in time from step S2, or at the same time. For example, a customer may activate an account shortly after establishing it, but not access the account for several days or weeks thereafter, A customer may also wish to activate an account and utilize it at the same time, such as when the customer wishes to pay for a purchase at a store.

In one or more embodiments, this step comprises determining if a customer is accessing a bank, automated teller, customer service representative, account provider website, remote payment station or the like. In order to determine if the customer is attempting to access an account, particular account information and associated access data is required. This data may be provided to the account provider or other account access controlling entity in a number of manners. In one or more embodiments, the account information may be directly provided by the customer, as through data input into a website or spoken to an account representative, or by reading the information from the access media.

The customer may wish to access the account for a number of reasons. For example, in the event a customer wishes to complete a purchase from a vendor, such as on-line or at a store, the customer may seek to access the account to pay for the purchase. The customer may seek access to the account to obtain funds from an automated teller machine.

In one or more embodiments, data must be provided to the account provider to establish the entitlement of the customer to access the designated account. This information may comprise the account signature and/or access code. Again, the particular means and/or method by which this information is provided may vary. In an embodiment where a customer is seeking to access an account using an access media, the account signature may be read or scanned from the card, and the access code may be provided by the customer, such as through a keypad. The customer may also provide such information through a variety of data input devices, such as a computer or customer station at a store, or provide the information directly to an account representative.

When a customer wishes to access an account, in a step S4 it is determined if the access to the account is permitted. In one or more embodiments, and referring to FIG. 1(c), this step includes a step S4a of determining if the provided account access information is correct and complete. In one or more embodiments, this step comprises comparing the provided account identification and/or access information to that associated with the account which the customer is seeking to access. If the required information has not been provided or is not correct, access to the account is denied. The customer may then be directed to contact the account provider and/or attempt to re-enter the required data in case there was an error in providing or transmitting it to the provider.

If the requisite access information is provided, then in a step S4b, it is determined if the account is closed. If the account has been closed, then access to the account is denied. The account may be closed at the request of the customer, upon violation of account terms and conditions or for a wide variety of other criteria or reasons.

If the account is not closed, then in a step S4c, it is determined if the account is expired. The account may be determined to be expired if a current date is the same as or time-wise later than the expiration date assigned to the account. If the account is expired, the customer is not permitted to access the account directly. Preferably, in that situation, the customer may access the account only through the account provider. The customer may contact the account provider and arrange for the removal of any funds remaining in the account. Alternatively, the customer may be permitted to re-activate the account with a new expiration date.

If in step S4 it is determined that access is permitted to the account, then in step S5, the customer is permitted to utilize the account. As described below, a variety of transactions, interactions with and manipulations to the account are permitted.

Referring to FIG. 1(d), in one or more embodiments, in a step S6, a customer is permitted to utilize the account to make a payment to a third party. A variety of methods may be implemented to effectuate this step. In one or more embodiments, in a step S6a, it is determined if the account is a charity account. If so, in a step S6b, funds are transferred from the charity account to a selected charity.

In one or more embodiments, when a charity account is established, the account provider designates the account a charity account. At that time, a customer may designate one or more charities to which funds placed in the account are to be distributed to. These funds may be distributed in accordance with the specific instruction of the customer at a later date, or at a predetermined time or in accordance with a predetermine schedule. The amount of the funds to be distributed may be designated by the customer as well. In one or more other embodiments, the customer may designate the charity(ies) to which funds are to be distributed after the account has been established.

In one or more embodiments, the finds which are distributed to the charity are transferred electronically from the account by the account provider to an account belonging to the charity or an intermediate escrow account or the like from which the charity may obtain payment. In other embodiments, the funds may be mailed or transmitted in other manners.

If the account is not a charity account, then it is determined in a step S6c if the account is a promotional account. If the account is a promotional account, then in a step S6c, the account may be used to purchase or pay for goods from specific parties. Preferably, the account provider must verify that the purchase is being made from one of the authorized parties. Normally, when the purchase is being made, the vendor will transmit vendor identification information along with the customer's account information. The account provider can verify the vendor from the provided vendor information.

If in step S6c it is determined that the account is not a promotional account, then it is determined that the account is a customer or allowance account which may be used as the source of payment for a transaction with, in general, any party. In step S6e, the purchase or other transaction is then facilitated by debiting the account.

It will be appreciated that a variety of steps other than those described may be associated with the payment of a purchase from the account. For example, in one step, the account provider must generally verify that sufficient funds exist in the account to permit the transaction. If sufficient funds do not exist, then the transaction may not be permitted. Alternatively, as described below, the account may be provided with a “credit” or “overdraft” feature which would still permit the customer to access the account.

As part of the transaction, the particular vendor may send information which facilitates the transfer of funds from the customer's account to the vendor's account by the account provider. For example, this information may comprise a vendor identification or account number.

As provided above, the method and apparatus by which the customer accesses the account to facilitate a purchase may vary. For example, if the customer is purchasing goods at a store, the customer may swipe their access media through a card reader and enter their access code. If the purchase is through a web-site or similar on-line access, the data may be input into a graphical user interface of the site.

In accordance with one or more embodiments of the invention, the payment for purchase may be arranged as an automated debit from the account. For example, a customer may arrange for payments to be made from the account on a periodic basis, such as in response to monthly amounts due a party (such as for a car payment or the like). In such event, the customer may provide the necessary debit information to the account provider.

In one or more embodiments, a purchase may be made in the form of an automatic funds transfer. For example, a customer may arrange with a particular vendor an arrangement where payment for the goods or services is made automatically. The customer provides the vendor with the account data which is then used by the vendor at one or more times subsequent thereto to affect payment. As an example, a customer may provide account data to their electric company. The electric company may then receive payment for the electricity supplied to the customer each month directly from the account through the account provider without intervention by or acts required by the customer. In this embodiment, the step of the customer accessing the account, step S3, generally comprises the customer providing the account data to the vendor or other party and then the vendor accessing the account as agent of the customer.

As one aspect of utilizing the account, as illustrated in FIG. 1(d), in a step S7, in one or more embodiments a customer may deposit funds into the account. A variety of methods may be implemented to effectuate this step. In one or more embodiments, this step includes a step S7a of determining if the account is an allowance type account. If so, then in a step S7b, funds are periodically transferred into the account. If the account is an allowance account, a customer will have provided the account provider with a source of funds from which a transfer into the account is to be made. The source of funds may be a customer's credit card, a bank account, or another account in accordance with the present invention. The customer will also have provided the account provider with specific instructions as to when funds are to be deposited, in what amount and the like.

If the account is not an allowance type account, then in a step S7c, the customer must specifically arrange for the particular transfer of funds with the account provider. For example, the customer may access a web-site or customer representative and provide source funds data. This data may comprise credit card information, bank account and routing information or the like. The customer may also arrange for funds transfer between accounts at a bank or similar provided customer station, phone controlled system or the like.

As one aspect of utilizing the account, as illustrated in FIG. 1(d), in a step S8, in one or more embodiments a customer may withdraw funds from the account. A variety of methods may be implemented to effectuate this step. In one or more embodiments, the funds withdrawal may comprise the issuance of currency such as U.S. or other dollars, or other media. In one or more other embodiments, the withdrawal may comprise the transfer of funds to another entity or account.

In general, when the customer desires to obtain currency, the customer travels to an automated teller machine (ATM), bank or similar currency dispensing location. In such event, the step of providing the requisite account data (see step S3) may comprise swiping an account media and inputting an access code. In the event the customer does not have an access media, the customer may provide the requisite data directly to a teller or other bank personnel for input into a system.

If the customer desires to withdraw funds and have the funds transferred into another account, the customer may be permitted to do such over the phone, via the account provider's web site, or at a bank or other location. In this regard, the number of locations at which a customer may effectuate the transfer is not constrained to locations where currency can be dispensed.

If the customer requests funds, and if such funds exist in the account, the customer is provided with funds. This step may include the step of transmitting the fund request to the account provider and the account provider comparing the amount of funds requested versus the total amount of funds in the account. If the funds exist, then the account provider may send a signal or other indication that it is permissible to dispense the funds.

In one or more embodiments, the customer is permitted to request currency or a transfer. If currency is requested, then currency is dispensed. If a transfer is requested, then the funds may be transmitted electronically to a new account. In the event the funds are to be transferred to another account, the customer provides the necessary information, such as the receiving account number and/or routing number and/or receiving party information.

As one aspect of utilizing the account, as illustrated in FIG. 1(d), in a step S9, in one or more embodiments a customer may obtain account information and manage their account. A variety of methods and devices may be utilized to effectuate this step. For example, a customer may call an automated telephonic information system, call a customer service representative or access a web site belonging to the account provider. In one or more embodiments, certain information and transactions may be permitted through an automated teller machine or similar remote access site.

In one embodiment, this step may include one or more of the following steps. In a step S9a, a customer may be permitted to obtain their account balance. The account balance may be provided on a viewing screen or printed on paper.

In one or more embodiments, in a step S9b, a customer may obtain the account limit for their account. The limit value may be displayed to the customer if the customer is located at a display, or may be printed onto a media, such as paper, and dispensed or mailed to the customer. If the customer is utilizing a phone system, the information may be transmitted over the phone.

In one or more embodiments, in a step S9c, a customer may change information associated with their account. This information may comprise their name, address, telephone number, the name(s) of parties permitted to access the account and the like.

In a step S9d, a customer may change their access code or similar access information. For example, in one embodiment, the account provider may assign the customer the access code when the account is established. In accordance with this step, the customer may change this access code to a code of their selection.

In a step S9e, a customer may obtain information regarding transactions associated with the account. This information may include information regarding fund deposits, withdraws and other transactions. In one or more embodiments, the customer may obtain information regarding an amount paid or transferred out of the account, the date of the transfer and the party to whom the amount was paid or transferred. The customer may obtain information regarding an amount deposited or transferred into the account, the date of the transfer and the origin of the funds.

In a step S9f, a customer may close the account. When closing the account, the customer may indicate to the account provider the location to which any funds remaining in the account are to be transferred.

In a step S9g, a customer may re-activate an account in order to change its expiration date. For example, before an account expires, a customer wishing to utilize the account for a longer period of time may elect to re-set the expiration date for the account. In one or more embodiments, the date is automatically set by the account provider, such as by adding a period of time to the current expiration date or the current date. In one or more other embodiments, the customer may select a new expiration date in the future.

As one aspect of utilizing the account, as illustrated in FIG. 1(c), in a step S10, in one or more embodiments a customer may change the status of the account. A variety of methods may be implemented to effectuate this step. In a step S10a, a customer may change the account type, such as from a customer account to a charity or other account, or vice versa. In a step S10b, a customer may merge one account with another account. For example, a customer having two accounts may wish to merge the accounts into a single account. A customer having one account may establish another and then merge or eliminate the first account in favor of the second.

Several examples of account merging are provided below:

John Doe's Debit Accounts

| Account Type | Balance | Status |
|---|---|---|
| $250 Debit Account | $100 Remaining | Active until 1/1/01 |
| $150 Debit Account | $50 Remaining | Active until 4/1/01 |

After merging accounts into a new account:

John Doe's Debit Accounts

| Account Type | Balance | Status |
|---|---|---|
| $250 Debit Account | $0 Remaining | Closed |
| $150 Debit Account | $0 Remaining | Closed |
| $150 Debit Account | $150 Remaining | Active until 6/1/01 |

Alternatively, the owner of the accounts may wish to transfer the $100.00 remaining from the $250 account into the $150 account with $50.00 remaining. This would close the $250 debit account and establish a new balance of $150 in the $150 debit account. An example of this transaction is as follows:

John Doe's Debit Accounts

| Account Type | Balance | Status |
|---|---|---|
| $250 Debit Account | $100 Remaining | Active until 1/1/01 |
| $150 Debit Account | $50 Remaining | Active until 4/1/01 |

After transferring the remaining amount into the $150 account:

John Doe's Debit Accounts

| Account Type | Balance | Status |
|---|---|---|
| $250 Debit Account | $0 Remaining | Closed |
| $150 Debit Account | $150 Remaining | Active until 4/1/01 |

A customer may also be permitted to close the account. If the account is empty, the account is simply closed by the account provider so that further access to the account by the customer is prevented. In the event funds exist in the account, the customer may be provided with the option of transferring the funds to another location or account, or obtain the funds from the account provider by mail.

In accordance with one or more embodiments of the invention, the account provider may provide a credit line or “overdraft” protection for the account. This option may be provided to the customer for free or upon payment of specific service charges. In accordance with this embodiment, in the event a customer wishes to withdraw funds from the account (whether to obtain currency, transfer to another account or payment for goods/services) in an amount greater than that which exists in the account, the account provider may supply the funds to the customer.

In one or more embodiments, the account provider may charge the customer a specific fee for utilizing the credit line, such as a per usage fee, interest or the like. In one or more embodiments, after a particular transaction which exceeds the amount of funds in the account, the account is frozen until sufficient funds are placed in the account or provided to the account provider to cover the funds deficiency.

One or more embodiments of the invention comprise apparatus for use in performing the above-described methods. As stated above, this apparatus may include an access media, such as a card, check, chip or the like. The apparatus may also include a wide variety of devices for interacting with the account provider and/or account. These devices may include some existing devices, such as existing bank teller machines, card reading devices, and data receiving and transmitting devices.

In one or more embodiments, a customer is permitted to establish and interact with their account via a website or similar on-line access. The website may include a graphical user interface designed to provide information to the customer and prompt and accept that information. The website may have multiple levels or pages. For example, the website may have a home page or “log-in” page which prompts a customer to either identify that they are a new customer and wish to establish or activate an account or identify themselves as an existing customer and have them provide the requisite account information.

If the customer is a new customer, the customer may be sent to a webpage at which information is provided to the customer about the various accounts which may be established. This or other pages may include prompts for providing the data necessary to establish an account.

If the customer is an existing customer and provides the necessary information to access the account (as in Step S3-S5 set forth above), then the customer may be presented with a menu page. At this page the customer may be selected with a menu of items from which to select. These items may be similar to those of steps S7-10. For example, a customer may be provided with a “manage account” item. Upon selecting this item, the customer may be presented with a number of sub-menu items. These items may comprise those items identified in steps S9a-f.

In one or more embodiments, a webpage may display account information for more than one account belonging to a customer. A variety of means may then be presented to the customer for use in manipulating these accounts. For example, a customer may then be permitted to “drop and drag” funds or the like from one account to another.

In one or more embodiments, the account provider has one or more devices adapted to store account information and receive and transmit account data, data representing funds transfers and the like. The account provider may have a system which includes a data storage device, a data input device and a data transmitting device. The data storage device may comprise one or more hard drives or similar elements used to store account data. Modems, servers or similar devices may be used to transmit and receive data. This system may include one or more processors arranged to process data.

The devices used to implement the present invention may be incorporated into existing systems facilitating monetary and commercial transactions. For example, the access media associated with an account in accordance with the present invention may be utilized with current card-reading devices.

In accordance with one or more embodiments of the invention, an account provider may issue accounts associated with access media which are available for purchase by customers. For example, an account provider may associate an account with an access media. The access media may have associated therewith an expiration date, account data and a maximum value. A customer may “purchase” the account and associated access media at a retail location. When the account provider is a bank, the bank may place access media on sale at retail locations such as grocery and retail stores.

A customer purchases the account and card by paying the retailer (who in turn pays the account provider). In one or more embodiments, the customer may thereafter access the account by activating the account. This may comprise calling the account provider after purchase. At that time, the account provider may provide the customer with an access code for use in using the access card. The access code could be provided on the card, but this arrangement has added security in that the account provider can ensure that the account is only accessed once it has been paid for.

In this embodiment, a customer may conveniently obtain a “pre-paid” account for themselves or for another party. The account may be used in similar fashion to a credit or ATM card, permitting purchases from any vendor and permitting access to cash from any of a variety of cash-dispensing locations.

It will be noted that in this embodiment, the step of establishing the account is generally accomplished by the account provider without input from the customer. In one or more embodiments, after purchasing or obtaining the access card, a customer may be required or permitted to provide additional information in order to access the account.

It is preferred that the access card indicate the expiration date of the access media. If the access media and associated account is expired, the purchase is not permitted. If the access media is about to expire, the customer may purchase it and, if the customer wishes to extend the expiration date, contact the account provider after purchase to do so. In one or more embodiments, the expiration data may not be printed on the access media, but when it is purchased scanned, read or the like by the vendor to ensure that it is still valid. When a purchase of an access media is made, the expiration data may then be reset a predetermine time from the purchase, with this information scanned onto the card or otherwise associated with the account.

In the above-described arrangement, each access media, once paid for, generally has the same characteristics as cash. A customer may pay for goods using the purchased access media. A customer may deposit the funds associated with the access media into another account, or transfer it to another party.

The present invention has numerous benefits and advantages. First, an account of the present invention is configured to permit minors to make financial transactions. In accordance with the invention, a debit account is established by or for the minor. Because of the existence of the funds in the account, a minor may complete a transaction without concern to the account provider/financial institution that the minor will pay for goods.

In one or more embodiments, this arrangement permits a customer to “buy” an account for use by another person in a fixed amount. In this manner, the account may be used as a gift. This arrangement has the advantage that the recipient of the account can utilize the funds associated with the account to make a purchase or pay for goods/services from essentially any location. The recipient may purchase goods on-line or at a store. The recipient is not limited to a particular store or mall.

The customer may also utilize one or more of the accounts in similar fashion to travelers checks. Because the funds associated with the accounts are different, a loss such as by theft of a single access media does not affect the remaining funds. For added security, each access media may have a different access code.

Parents and others may arrange an account for their children. The children are not permitted to spend more money than their parents provide, because of the arrangement of the account. On the other hand, the parents can provide their children with a convenient means for paying for items even though they may be located a great distance apart. The parents may also access the account to track purchases and other transactions by their children. The parents may also arrange the account as an “allowance” account, where finds are placed into their children's account at predetermined intervals without specific action by the parents or children at the time of each deposit.

The methods and accounts of the present invention has several safety features. Because the account expires after a predetermined time, the risk that a thief may find and be able to use a lost access card is reduced. The account is associated with a unique account signature which is generated from data which is difficult to obtain.

The methods and accounts permit a wide range of transactions, including a number of very specific transactions which are not presently facilitated. For example, a vendor may establish promotional accounts for current and potential customers. One advantage of a promotional account is that a large company may establish accounts which customers can use at one or more of their stores located in different areas. For example, a retailer having outlet in Los Angeles and New York may issue cards associated with accounts for use by customer at either location. This arrangement is also advantageous for franchisees: the franchiser may sponsor a promotion for their franchisees whereby the discount or amounts provided to the customers are paid for by the franchiser.

A promotional account may also be a prize or award. A vendor may award an account to one or more customer who win a contest or drawing or the like. A vendor may also arrange the promotional account with an expiration date requiring the customer to utilize the account within a predetermined time.

A customer may establish a charity account for themselves, or a charity may establish an account for a customer. For example, a charity may seek donations from customers in the form of deposits into a charity account established by the charity for the customer.

In one or more embodiments, a customer or other user of a promotional account may be prevented from any account activities except use of the account to facilitate a purchase. The customer or user to whom the account is issued may be prevented from obtaining finds from the account (such as cash) or viewing data associated with the account such as the remaining balance or the like. A customer may also be prevented from merging the account or adding funds to the account. On the other hand, a vendor may be permitted to track all purchases and other uses of promotional accounts. In this manner, the vendor can obtain important data regarding the customer, including their spending habits, spending locations and similar information.

A business may use the account for business to business transactions. For example, a business may set up a master account and a number of sub or allowance accounts. The business may use the accounts to pay suppliers of goods and services. The master account may comprise a main account for the business and each allowance account an account relating to a particular vendor or project. Commensurate with billing or an accounting period, the business may have arranged an automatic transfer of funds from the master account to one or more of the allowance accounts, and from one or more of the allowance accounts to each particular supplier for their bill.

Another aspect of the invention will be described with reference to FIGS. 2(a)-(c). In general, this aspect of the invention comprises one or more methods and apparatus for securely storing data, and in other embodiments, accessing and manipulating the data.

One embodiment of a method of securely storing data will now be described in detail with reference to FIG. 2(a). In a first step S100, a user accesses a remote location. In a preferred embodiment, the remote location comprises a server accessible through a communications link. In one or more embodiments, this step comprises accessing a website location, such as a site called “UnderLocknKey.com.” As described below, this website may be accessed with a computer having a modem via an Internet connection using a web browser. The remote server may also be accessed directly over a telephone line or wireless communications link.

The remote server service may be offered by a bank or other entity for use, as described below, by a user to securely storing data. A user may be presented with the opportunity to join this service at a bank's location, or by signing up on-line or over the phone. This sign-up process may be similar to that described above, with a user providing identifying information and the service provider establishing an account for the user. In another embodiment, a user may access the service without pre-establishing an account.

In a step S101, a user is instructed to “log on” to the server. Preferably, this step comprises the user providing data to identify themselves. This information may comprise an account number and/or PIN number, in similar fashion to the embodiment of the invention described above. The information may alternatively, or in addition, comprise the user name, address or other identifying information. As described above, this account log on information may be pre-established by the user with the provider, or the first time that a user wishes to use the service, additional steps may be provided which permits the user to establish their log on information.

This remote location may be referred to as an “electronic safe deposit box,” since the remote location serves as a location for the storage of data, but the data being in electronic form. It will be appreciated that the term remote has no specific geographic connotation, but simply means a location independent of the original location of the user's data.

In a step S102, the user provides data to be stored at the remote server. The data may have a variety of forms, such as text (such as .rtf), images (such as a .gif) or a wide variety of other data in a wide variety of formats. Of course, if the data which the user wishes to store is originally in a physical form, such as a printed document, the user may scan the document to convert the information into an electronically stored and readable form. These methods of data conversion are well known.

In a preferred embodiment, the user transmits the data, preferably in the form of a data file, to the remote server using the communications or data transfer link. In one or more embodiments, the name of the user provides the file with a name. This name is preferably chosen by the user so that later the user can readily identify it.

In a step S103, the remote server is arranged to stamp the provided data with certain identifying information. In one or more embodiments, this information comprises a date and time that the data was received. The information preferably also includes information for identifying the user who provided the data. Preferably, the provider utilizes the same name as provided by the user to identify the file.

In a step 104, the data, as including the identifying information, is stored remotely. As described in greater detail below, the data may be stored on a wide variety of devices/media associated with the remote server.

In a step S105, the user is instructed to provide an encryption key and/or password. In one or more embodiments, this step includes the step of a user establishing an encryption key and password if one has not been established. The password may comprise a PIN or other password selected by or provided to the user. The encryption key may be chosen by the user or selected for them. The user preferably sends this key and/or password to the remote server when instructed.

In a step S106, the data which was stored is encrypted. A variety of encryption techniques may be used such as DSA, RSA or the like, as is well known. Of course, the encryption key which is provided to the user is associated with the particular encryption technique used to encrypt the data. Preferably, the encryption key which belongs to the user is a private key, such that only the user and the provider have access to the key which is used to encrypt the data.

In one or more embodiments, the encryption key is stored at the remote server and is used when the user identifies himself, such as with appropriate identification information including a PIN. In this arrangement, the user need not remember their encryption key.

Once encrypted, it will be appreciated that the data can not be decrypted for use, including reading, without a user providing the appropriate key. This ensures the security of the data, even though the data is stored on a server which may be accessible by a great number of parties.

In a step S107 a tag or other indicator is associated with the now encrypted data to indicate that it is “read-only.” This aids in ensuring that a party, whether the owner of the data or the operator of the remote server, does not inadvertently overwrite or change the data.

In a step S108, the user may disconnect from the service, such as by logging out, with the process then ending in a step S109. The log out process may comprise the sending of an indication to the remote server that the user has completed their session and that the link may be disconnected. The log out and log in process are useful for the provider in identifying the user and monitoring their activities. This information can be helpful in maintaining the security of the location. In addition, the log out process aids in ensuring that the link does not remain open and is not accessed later by another party.

A method of accessing stored data will now be described with reference to FIG. 2(b). In a first step S200, the user accesses the remote location, as described above with reference to step S100. In a step S201, the user logs on to the remote server, such as by providing identifying information, as described with reference to step S101.

In a step S202 the user requests access to a particular file. In one or more embodiments, the user may indicate the requested file by inputting its name. In one or more embodiments, the user may be provided with a list of files which are identified as associated with that user, from which the user may make a file selection.

In a step S203, the user is instructed to provide their encryption key and password. In a step S204, the provided key and password is then checked against the key and password for the user known to the provider. If the key and password are incorrect, the user is not permitted to access the file. As described briefly above, in one or more embodiments, the user's key may actually be stored at a remote location for use by the user. For example, the user may be permitted to store their key at the remote server at a location apart from the files, with the user permitted to access their key upon appropriate identification. This arrangement avoids the user having to remember their own key, but instead only a basic set of identifying information.

If the key and password are correct, then in a step S205, the file is unlocked. In one embodiment, this step comprises permitting access to the file. This step may also comprise the step of removing the “read-only” tag from the file/data. In a step S206, the file is decrypted.

In a step S207, the user is permitted to access the file. In one or more embodiment, this step may comprise the user opening and reading the file at the remote location. In one or more other embodiments, the user may obtain the file, such as by the remote server transmitting it to the user.

In a step S208, the user exits the system by logging out, and in a step S209 the process stops.

One or more embodiments of the invention comprise methods of manipulating data which is securely stored. One embodiment of a method of deleting a file will be described with reference to FIG. 2(c).

In a step S300, the user accesses the remote location, and in step S301 logs in to the remote server, as described with reference to steps S100-101 above.

Steps S302-S305 are similar to steps S202-205, with a user selecting a file, providing their key/password, and then unlocking the file. In a step S306, the user requests that the file be deleted. In a preferred embodiment, the a prompt is provided to the user requiring the user to again indicate their desire to delete the indicated file. If the user wishes the file to be deleted, in a step S307, the file is deleted. If not, or once the file is deleted, the process stops in a step S308.

It will be appreciated that a variety of other methods may be provided for manipulating the files. For example, a user may be permitted to change data associated with a file and then resave it. A user may also be permitted to merge multiple files.

In one or more embodiments, the user may encrypt the data before it is transmitted to the remote server. The data may then be re-encrypted at the remote server or simply stored. Likewise, the data may be decrypted at the user's computer or location when downloaded, instead of or in addition to being decrypted at the remote location. In one or more embodiments, it is preferred that the communications link and remote server be of a “secure” type, generally preventing third parties from intercepting the data. In such an arrangement, the data may be encrypted during transmission.

It will be also appreciated that the particular order of the steps described may vary. For example, the data which is provided by the user may be encrypted and tagged as read-only while the data is stored in a temporary location (such as RAM associated with the server), and then stored at a long-term storage location (such as a hard-drive).

The user may be permitted to accomplish one or more of the above-described steps by other than an on-line connection using a computer. For example, a user may be permitted to contact the provider by phone. Upon providing the identifying information, the user may select a particular file to be obtained. The provider may then arrange to have the file contents printed and mailed, faxed, or emailed to the user.

The apparatus which is used to implement the above-described method of securely storing and manipulating the data may comprise apparatus similar to that utilized to implement the monetary and commercial transaction embodiment of the invention. Namely, a user may utilize a computer to access a remote server. The computer may include a processor, a data storage device, a display for displaying information, at least one data input device such as a keyboard, and a communications device, such as a modem. In this regard, the user's computer may be referred to as a first or local server. The user may utilize a wide variety of other devices as well, such as stand-alone specially configured stations and the like which facilitate the above-described methods.

The remote server may comprise a device for accepting and receiving data via a communications link, and for manipulating that data. The remote server may be associated with a wide variety of data storage devices, such as CD R/W devices, hard drives, discs, tape drives and the like, and a wide variety of storage media, such as tapes, CD's the like. It will be appreciated that the various actions which are carried out at the remote location may be implemented with appropriate hardware and/or software.

In one or more embodiment of the invention, a user interface may be provided to aid the user in storing, downloading, deleting and otherwise manipulating the data. The user interface may be presented as a web page, or may comprise a graphical user interface associated with a program executed on the user's computer. In one or more embodiments, the interface is arranged to display and accept data, and may include prompts. For example, the interface may be arranged to display account and password input prompts to a user when logging in. The interface may be arranged to display a variety of menus which the user may use to cause certain actions to occur, such as obtaining a listing of saved files, deleting files, downloading files and the like.

A variety of other utilities may be provided to the user. For example, a user may be permitted to change their access code/PIN, change their key and/or password, rename files and the like. A user may also be permitted to group files for easy identification. For example, the user may be permitted to create a “pictures” folder in which all of their picture files are stored and a “records” folder in which all of their records are stored. Of course, the files need not all be stored in the same physical location at the remote location, but only the designation of the files may be presented to the user in such an arrangement or grouping.

In one or more embodiments, the above-described service is provided for a fee paid by the user. The fee which is paid may be tied to one or more factors, such as the amount of storage space required and/or time the data is to be stored.

In one or more embodiments, each user may be provided with a mailbox. A user may obtain messages from the provider at this mailbox, such as messages regarding how much of their allocated space is used. A user may directed another user to send data to their mailbox, such as by email, facsimile or the like. A user may then store this data at the remote server by logging in, designating the file(s) in their mailbox, etc. as described above. The mailbox may be specific to the user or may be a general box or other storage location.

The methods and apparatus for storing and accessing data in a secure fashion as described have numerous advantages. First, the data is stored at a remote location which avoids the data being lost due to theft, destruction or the like as if the data was stored at a home or the like. Yet, the data is readily accessible, unlike if the data was stored at a safe deposit box. In fact, one advantage is that a user may access this data from any location, not just their house or the bank. For example, if required, a user may access the data while on a business trip or vacation. In addition, a user may store data from any location. This avoids the need for the user to transport the data to a specific location. For example, if a user comes into possession of certain important data files, instead of transporting diskettes or the like to the bank vault, the user may store the data immediately.

The data is securely stored as a result of the verification steps necessary to access the data, and because the data is encrypted. This ensures that only the owner of the data may access it.

The information stamp associated with a particular file may be used to establish authenticity of the data. For example, the date and time stamp may be used to establish, such as in a dispute, that the user had possession of the data at least as of the date and time associated with the file.

It will be understood that the above described arrangements of apparatus and the method therefrom are merely illustrative of applications of the principles of this invention and many other embodiments and modifications may be made without departing from the spirit and scope of the invention as defined in the claims.

I claim:

1. A method of a securely storing data comprising:
establishing a communications link between a first server and a second server located remotely from said first server;
identifying a user of the first server;
transmitting data to be stored from the first server to the second server via the communications link;
associating identifying information regarding the user with the transmitted data;
encrypting the transmitted data; and
storing the encrypted transmitted data at the remote location.

2. The method in accordance with claim 1 wherein said transferred data is in the form of a data file.

3. The method in accordance with claim 2 wherein said data file is named by said user.

4. The method in accordance with claim 1 wherein the data is encrypted with a private key identified by said user.

5. The method in accordance with claim 1 wherein said data is encrypted in accordance with an encryption method selected from the group consisting of RSA and DSA.

6. The method in accordance with claim 1 including the step of identifying said data as read-only after said data has been encrypted.

7. The method in accordance with claim 1 wherein said first server comprises a computer.

8. The method is accordance with claim 1 wherein said communications link includes the Internet.

9. The method in accordance with claim 1 wherein at least a portion of said communications link includes a wireless communication channel.

10. A method of accessing data belonging to a user stored at a data storage device at a location remote from the user comprising:
establishing a communication link with said data storage device at said remote location;
transmitting user identification information to said data storage device for establishing access to said data;
requesting access to data in a stored file;
identifying a decryption key;
verifying said decryption key with key information stored at said data storage device associated with said user identification;
decrypting the requested stored data; and
transmitting at least part of said decrypted data from said data storage device to said user.

11. The method in accordance with claim 10 including the step of manipulating said stored data after its decryption.

12. The method in accordance with claim 11 wherein said manipulating step comprises deleting at least a portion of said data.

13. The method in accordance with claim 10 wherein said step of transmitting user identification information comprises transmitting an identification code associated with said user's identity.

14. The method in accordance with claim 10 wherein said step of identifying a decryption key comprises transmitting a password to said data storage device, said password associated with a decryption key.

15. The method in accordance with claim 10 wherein said data storage device is associated with a remote server and said step of establishing a communication link comprises establishing a communication link with said remote server.

16. A method of a securely storing data comprising:
establishing a communications link with the world wide web;
accessing a server at a remote location having an domain address associated with said world wide web;
transmitting user identification information to said server;
transmitting data to be stored to the server;
associating information regarding the identity of said user and date and time information with the transmitted data;
transmitting information identifying an encryption key to said server;
encrypting said transmitted data with said identified encryption key; and
storing the encrypted transmitted data at the remote location.

17. The method in accordance with claim 16 wherein said step of transmitting information identifying an encryption key comprises transmitting a password identifying said key.

18. The method in accordance with claim 16 including the step of preventing alteration of said stored data.

19. The method in accordance with claim 18 including the step of identifying said information as read-only after its encryption.

20. The method in accordance with claim 16 wherein said storing step comprises storing said encrypted data at a mass storage device associated with said server.
